(19) United States
(12) Patent Application Publication
(10) Pub. No.: US 2026/0247115 A1
(43) Pub. Date: Aug. 20, 2026

(54) COMMUNICATION METHOD, ELECTRONIC DEVICE, AND STORAGE MEDIUM

(71) Applicant: BEIJING XIAOMI MOBILE SOFTWARE CO., LTD., Beijing (CN)

(72) Inventor: Xiandong DONG, Beijing (CN)

(73) Assignee: BEIJING XIAOMI MOBILE SOFTWARE CO., LTD., Beijing (CN)

(21) Appl. No.: 19/164,237

(22) PCT Filed: Mar. 14, 2023
(86) PCT No.: PCT/CN2023/081438

§ 371 Date: Sep. 11, 2025

(51) Int. Cl. H04W 4/38; H04W 24/08

(52) U.S. Cl. CPC H04W 4/38; H04W 24/08

(57) ABSTRACT

A communication method is applied to a sensing by proxy (SBP) sensing responder, and includes: receiving an SBP request frame, in which the SBP request frame includes first expiry parameter information indicating an expiry time of an SBP procedure; according to the first expiry parameter information, setting second expiry parameter information indicating an expiry time of a sensing measurement procedure, and determining a sensing measurement setup request frame of the sensing measurement procedure, in which the sensing measurement setup request frame includes the second expiry parameter information; and sending the sensing measurement setup request frame.

### CROSS-REFERENCE TO RELATED APPLICATIONS

The present application is a U.S. National Phase of International Application No. PCT/CN2023/081438, filed with the State Intellectual Property Office of P. R. China on Mar. 14, 2023, the contents of which are incorporated herein by reference in their entireties for all purposes.

### TECHNICAL FIELD

The present disclosure relates to a field of mobile communication technologies, and specifically, the present disclosure relates to a communication method, an electronic device, and a storage medium.

### BACKGROUND

Among Wi-Fi technologies currently under study, a wireless local area network (WLAN) sensing technology may be supported, for instance, in application scenarios such as location discovery, proximity detection, and presence detection in dense environments (such as home and enterprise environments).

During a WLAN sensing process, the identities of a station (STA) and an access point (AP) may usually be interchanged. For example, they both may serve as a sensing initiator or a sensing transmitter. In a case of acting as the sensing initiator or the sensing transmitter, the AP may communicate simultaneously with a plurality of STAs, but the STA does not have the above mentioned functions and may only perform one-to-one communication with a single sensing responder, which causes waste of a spectrum resource on one hand and increases latency on the other hand. For a communication scenario with a high requirement on latency, the latency requirement may not be met. To solve this problem, there is proposed a method of using the AP as a proxy of the STA for WLAN sensing measurement, namely sensing by proxy (SBP).

In an SBP procedure, a method for terminating the SBP needs to be provided to further improve the SBP mechanism.

### SUMMARY

In an aspect, an embodiment of the present disclosure provides a communication method, performed by a sensing by proxy (SBP) responder, including:

receiving an SBP request frame, in which the SBP request frame includes first expiry parameter information indicating expiry time of an SBP procedure;

setting, based on the first expiry parameter information, second expiry parameter information indicating expiry time of a sensing measurement procedure, and determining a sensing measurement setup request frame of the sensing measurement procedure; in which the sensing measurement setup request frame includes the second expiry parameter information; and sending the sensing measurement setup request frame.

In an aspect, an embodiment of the present disclosure provides a communication method, performed by a sensing by proxy (SBP) initiator, including:
determining an SBP request frame, in which the SBP request frame includes first expiry parameter information indicating expiry time of an SBP procedure;
sending the SBP request frame, to instruct an SBP responder to set second expiry parameter information indicating expiry time of a sensing measurement procedure based on the first expiry parameter information, and to determine a sensing measurement setup request frame of the sensing measurement procedure; in which the sensing measurement setup request frame includes the second expiry parameter information.

In an aspect, an embodiment of the present disclosure provides a communication method, performed by a station, including:
receiving a sensing measurement setup request frame sent by a sensing by proxy (SBP) responder; in which the sensing measurement setup request frame includes second expiry parameter information indicating expiry time of a sensing measurement procedure, the second expiry parameter information is set by the SBP responder based on first expiry parameter information, and the first expiry parameter information indicates expiry time of an SBP procedure.

### BRIEF DESCRIPTION OF THE DRAWINGS

In order to explain technical solutions in the embodiments of the present disclosure more clearly, the drawings described in the embodiments of the disclosure will be briefly introduced below. Obviously, the drawings described below are merely some embodiments of the disclosure. For ordinary technicians in the field, without the need for creative efforts, other drawings may be obtained based on these drawings.

FIG. 1 is a flowchart illustrating a communication method provided in an embodiment of the present disclosure;

FIG. 2 is a schematic diagram of a first example in an embodiment of the present disclosure;

FIG. 3 is a flowchart illustrating a communication method provided in an embodiment of the present disclosure;

FIG. 4 is a flowchart illustrating a communication method provided in an embodiment of the present disclosure;

FIG. 5 is a block diagram illustrating an electronic device provided in an embodiment of the present disclosure;

FIG. 6 is a block diagram illustrating an electronic device provided in an embodiment of the present disclosure;

FIG. 7 is a block diagram illustrating an electronic device provided in an embodiment of the present disclosure;

FIG. 8 is a block diagram illustrating an electronic device provided in an embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

The terms used in the embodiment of the present disclosure are merely for the purpose of describing a particular embodiment and are not intended to limit the embodiment of the present disclosure. The terms “a” and “the” in the singular form as used in the embodiment of the present disclosure and the accompanying claims are also intended to include the majority form, unless the context clearly indicates otherwise. It should also be understood that the term “and/or” as used herein refers to and encompasses any or all possible combinations of one or more associated listed items. For example, “A and/or B” may represent three situations: A exists alone, A and B exist simultaneously, or B exists alone. The character “/” generally indicates that the objects before and after it have a “or” relationship. The term “multiple” means two or more. Given this, in the embodiments of the present disclosure, “multiple” may also be understood as “at least two”.

It is understood that although the terms first, second, third, etc. may be used to describe various information in the embodiments of the present disclosure, such information should not be limited to these terms. These terms are used only to distinguish the same type of information from one to another. For example, without leaving the scope of the present disclosure, the first information may also be referred to as the second information, and similarly, the second information may also be referred to as the first information. Depending on the context, the words “if” used here can be interpreted as “in . . . when” or “in response to determining”.

In conjunction with the drawings in the embodiments of the present disclosure, the technical solutions in the embodiments of the present disclosure will be clearly and completely described below. Obviously, the described embodiments are only some embodiments of the present disclosure, but not all the embodiments. Based on the embodiments of the present disclosure, all other embodiments obtained by ordinary technicians in the field without making creative efforts fall within the protection scope of this disclosure.

The embodiments of the present disclosure provide a communication method, an electronic device, and a storage medium, aiming to provide an SBP terminating method.

The method and the apparatus are based on the same application concept. Since the method and the apparatus have similar principles for solving problems, for implementations of the apparatus and the method, reference may be made to each other. The repetitive parts will not be elaborated again.

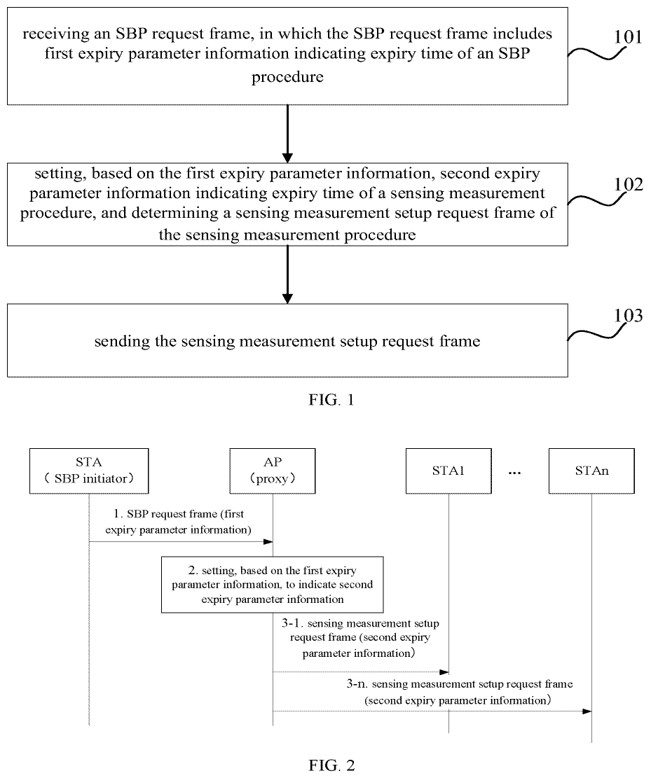

As shown in FIG. 1, an embodiment of the present disclosure provides a communication method. Optionally, this method may be performed by a sensing by proxy (SBP) responder, in which the SBP responder may be an access point (AP), and the SBP initiator may be a station (STA).

Optionally, in the embodiment of the present disclosure, the AP, for example, a device with a wireless-to-wired bridging function, is responsible for extending a service provided by a wired network to a wireless network; the STA, for example, an electronic device with a wireless network access function, provides a frame delivery service to enable information transmission. The method may include the following steps.

Step 101, an SBP request frame is received, in which the SBP request frame includes first expiry parameter information indicating expiry time of an SBP procedure.

In a case that an SBP initiator initiates the SBP procedure, the SBP initiator sends an SBP request frame to an SBP responder to request setup of the SBP procedure. The SBP initiator carries the first expiry parameter information in the SBP request frame, and the first expiry parameter information indicates the expiry time of the SBP procedure.

Optionally, the first expiry parameter information may be such as an SBP procedure expiry exponent. The value of the SBP procedure expiry exponent includes an unsigned integer, with the unit being millisecond (ms). For example, in a case that the value of the SBP procedure expiry exponent is zero and there is no frame exchange sequence, then the SBP procedure terminates.

Step 102, second expiry parameter information indicating expiry time of a sensing measurement procedure is set based on the first expiry parameter information, and a sensing measurement setup request frame of the sensing measurement procedure is determined; in which the sensing measurement setup request frame includes the second expiry parameter information.

After the SBP responder receives the SBP request frame, based on the first expiry parameter information in the SBP request frame, the SBP responder determines and sets the second expiry parameter information of the sensing measurement procedure.

Specifically, after the SBP responder receives the SBP request frame, the SBP responder initiates the sensing measurement procedure (a triggered based sounding (TB) sensing measurement) based on the SBP request frame, and establishes the sensing measurement procedure by sending the sensing measurement setup request frame to an STA. The second expiry parameter information for indicating the expiry time of the sensing measurement procedure is carried in the sensing measurement setup request frame, and the second expiry parameter information is used to terminate the sensing measurement procedure.

Furthermore, the sensing measurement procedure initiated by the SBP responder terminates before termination of the SBP procedure.

Step 103, the sensing measurement setup request frame is sent.

The SBP responder sends the sensing measurement setup request frame, aiming to initiate a TB sensing measurement procedure and complete the SBP procedure.

As a first example, refer to FIG. 2. FIG. 2 illustrates an application scenario of the communication method provided by an embodiment of the present disclosure.

As the SBP initiator, the STA first performs step 1, in which the SBP request frame is sent to the AP (which is a proxy, i.e. the SBP responder) and first expiry parameter information indicating expiry time of an SBP procedure is carried in the SBP request frame.

The AP first performs step 2, in which second expiry parameter information indicating expiry time of a sensing measurement procedure is set based on the first expiry parameter information, and a sensing measurement setup request frame of the sensing measurement procedure is determined.

Then step 3 is performed (3-1, 3-2, . . . 3-n, respective sub-steps may be performed simultaneously or sequentially). The sensing measurement setup request frame is sent to STA1 to STAn serving as the sensing responders, respectively. The second expiry parameter information is carried in the sensing measurement setup request frame, to indicate expiry time of the sensing measurement procedure.

In the embodiments of the present disclosure, the SBP responder receives an SBP request frame, and obtains first expiry parameter information from the SBP request frame; sets, based on the first expiry parameter information, second expiry parameter information indicating expiry time of a sensing measurement procedure, and determines a sensing measurement setup request frame of the sensing measurement procedure; and sends the sensing measurement setup request frame, in which the sensing measurement setup request frame carries the second expiry parameter information. The embodiment of the present disclosure provides a method for terminating the SBP to further improve the SBP mechanism.

An embodiment of the present disclosure provides a communication method. Optionally, the method may be performed by a sensing by proxy (SBP) responder and the method may include the following steps:
receiving an SBP request frame, in which the SBP request frame includes first expiry parameter information indicating expiry time of an SBP procedure;
setting, based on the first expiry parameter information, second expiry parameter information indicating expiry time of a sensing measurement procedure, and determining a sensing measurement setup request frame of the sensing measurement procedure; in which the sensing measurement setup request frame includes the second expiry parameter information; and
sending the sensing measurement setup request frame.

The expiry time of the SBP procedure is later than the expiry time of the sensing measurement procedure to ensure that the sensing measurement procedure initiated by the SBP responder terminates before termination of the SBP procedure, thereby standardizing the SBP procedure.

An embodiment of the present disclosure provides a communication method. Optionally, the method may be performed by a sensing by proxy (SBP) responder and the method may include the following steps:
receiving an SBP request frame, in which the SBP request frame includes first expiry parameter information indicating expiry time of an SBP procedure, and the first expiry parameter information includes SBP procedure expiry exponent information;
setting, based on the first expiry parameter information, second expiry parameter information indicating expiry time of a sensing measurement procedure, and determining a sensing measurement setup request frame of the sensing measurement procedure; in which the sensing measurement setup request frame includes the second expiry parameter information; and
sending the sensing measurement setup request frame.

The first expiry parameter information includes an SBP procedure expiry exponent. The value of the SBP procedure expiry exponent includes an unsigned integer, with the unit being millisecond (ms). For example, in a case that the value of the SBP procedure expiry exponent is zero and there is no frame exchange sequence, then the SBP procedure terminates.

An embodiment of the present disclosure provides a communication method. Optionally, the method may be performed by a sensing by proxy (SBP) responder and the method may include the following steps:
receiving an SBP request frame, in which the SBP request frame includes first expiry parameter information indicating expiry time of an SBP procedure;
setting, based on the first expiry parameter information, second expiry parameter information indicating expiry time of a sensing measurement procedure, and determining a sensing measurement setup request frame of the sensing measurement procedure; in which the sensing measurement setup request frame includes the second expiry parameter information; and
sending the sensing measurement setup request frame.

The SBP request frame includes an SBP parameter information element. As an example, the format of the SBP parameter information element is shown in Table 1 below.

TABLE 1

| | | | | | sensing | sensing |
|---|---|---|---|---|---|---|
| information | | | element ID | SBP parameter | responder | responder |
| content | element ID | length | extension | control field | addresses | IDs |
| octets | 1 | 1 | 1 | 3 | 0 or | 0 or |
| | | | | | n*6 | variable |

As shown in Table 1, the first expiry parameter information may be such as an SBP procedure expiry exponent. The first expiry parameter information is carried in the SBP parameter control field of the SBP parameter information element.

Furthermore, the format of the SBP parameter control field is shown in Table 2 below.

TABLE 2

| | | SBP procedure | | | mandatory | preferred |
|---|---|---|---|---|---|---|
| | SBP | expiry | sensing | number of | number of | responder |
| content | request | exponent | responder | responders | responders | list |
| bits | 1 | 4 | 1 | 4 | 1 | 1 |
| bits order | B0 | B1-B4 | B5 | B6-B9 | B10 | B11 |

| | preferred number | mandatory preferred | |
|---|---|---|---|
| content | of responders | responders | reserved |
| bits | 4 | 1 | 7 |
| bits order | B12-B16 | B17 | B18-B23 |

An embodiment of the present disclosure provides a communication method. Optionally, the method may be performed by a sensing by proxy (SBP) responder and the method may include the following steps:
receiving an SBP request frame, in which the SBP request frame includes first expiry parameter information indicating expiry time of an SBP procedure;
setting, based on the first expiry parameter information, second expiry parameter information indicating expiry time of a sensing measurement procedure, and determining a sensing measurement setup request frame of the sensing measurement procedure; in which the sensing measurement setup request frame includes the second expiry parameter information; and sending the sensing measurement setup request frame.

The SBP request frame includes an SBP parameter information element.

The first expiry parameter information is carried in an SBP parameter control field of the SBP parameter information element. The second expiry parameter information includes measurement setup expiry exponent information. The value of the measurement setup expiry exponent information includes an unsigned integer, with the unit being millisecond (ms). For example, in a case that the value of the measurement setup expiry exponent information is zero and there is no frame exchange sequence, then the TB sensing measurement procedure terminates.

An embodiment of the present disclosure provides a communication method. Optionally, the method may be performed by a sensing by proxy (SBP) responder and the method may include the following steps:
receiving an SBP request frame, in which the SBP request frame includes first expiry parameter information indicating expiry time of an SBP procedure;
setting, based on the first expiry parameter information, second expiry parameter information indicating expiry time of a sensing measurement procedure, and determining a sensing measurement setup request frame of the sensing measurement procedure; in which the sensing measurement setup request frame includes the second expiry parameter information; and
sending the sensing measurement setup request frame.

The SBP request frame includes an SBP parameter information element.

The first expiry parameter information is carried in an SBP parameter control field of the SBP parameter information element. The second expiry parameter information includes measurement setup expiry exponent information.

The value of the measurement setup expiry exponent information is less than the value of SBP procedure expiry exponent information. The SBP initiator may set the value of the measurement setup expiry exponent based on the value set for the SBP procedure expiry exponent. The SBP initiator set the value of the measurement setup expiry exponent to be less than the value of the SBP procedure expiry exponent, so that the expiry time of the SBP procedure is later than the expiry time of the sensing measurement procedure, so as to ensure that the sensing measurement procedure initiated by the SBP responder terminates before termination of the SBP procedure, thereby standardizing the SBP procedure.

An embodiment of the present disclosure provides a communication method. Optionally, the method may be performed by a sensing by proxy (SBP) responder and the method may include the following steps:
receiving an SBP request frame, in which the SBP request frame includes first expiry parameter information indicating expiry time of an SBP procedure;
setting, based on the first expiry parameter information, second expiry parameter information indicating expiry time of a sensing measurement procedure, and determining a sensing measurement setup request frame of the sensing measurement procedure; in which the sensing measurement setup request frame includes the second expiry parameter information; and
sending the sensing measurement setup request frame.

The SBP request frame includes an SBP parameter information element.

The first expiry parameter information is carried in an SBP parameter control field of the SBP parameter information element. The second expiry parameter information includes measurement setup expiry exponent information.

The sensing measurement setup request frame includes a sensing measurement parameter information element. The sensing measurement parameter information element identifies parameter information necessary for the SBP initiator to initiate an SBP measurement procedure, such as bandwidth (BW), number of space-time streams (NST), and max long training field (LTF) etc.

As an example, the format of the sensing measurement parameter information element is as shown in Table 3 below.

TABLE 3

| | | | element | sensing | |
|---|---|---|---|---|---|
| information | element | | ID | measurement | sensing |
| content | ID | length | extension | parameter | subelement |
| octets | 1 | 1 | 1 | 5 | 0 or variable |

The second expiry parameter information (the measurement setup expiry exponent) is carried in a sensing measurement parameter field of the sensing measurement parameter information element. The format of the sensing measurement parameter field is as shown in Table 4 below.

TABLE 4

| | | | sensing | | | | |
|---|---|---|---|---|---|---|---|
| | | | measurement | measurement | | max TX | max RX |
| information | sensing | sensing | report | setup expiry | | HE-LTF | HE-LTF |
| content | transmitter | receiver | requested | exponent | BW | repetition | repetition |
| octets | 1 | 1 | 1 | 4 | 4 | 3 | 3 |

| information | max TX | max RX | number of | report | | | BSS color | |
|---|---|---|---|---|---|---|---|---|
| content | STS | STS | RX Antennas | timestamp | N_{b} | I_{Ng} | information | reserved |
| octets | 3 | 3 | 3 | 1 | 1 | 1 | 8 | 4 |

An embodiment of the present disclosure provides a communication method. Optionally, the method may be performed by a sensing by proxy (SBP) responder and the method may include the following steps:
receiving an SBP request frame, in which the SBP request frame includes first expiry parameter information indicating expiry time of an SBP procedure;
setting, based on the first expiry parameter information, second expiry parameter information indicating expiry time of a sensing measurement procedure, and determining a sensing measurement setup request frame of the sensing measurement procedure; in which the sensing measurement setup request frame includes the second expiry parameter information; and sending the sensing measurement setup request frame.

The SBP request frame includes an SBP parameter information element.

The first expiry parameter information is carried in an SBP parameter control field of the SBP parameter information element. The second expiry parameter information includes measurement setup expiry exponent information.

The SBP request frame includes a sensing measurement parameter information element. Regarding the format of the sensing measurement parameter information element, reference is made to the aforementioned Table 3, which is not elaborated here.

The second expiry parameter information is carried in a sensing measurement parameter field of the sensing measurement parameter information element. Regarding the format of the sensing measurement parameter field, reference is made to the aforementioned Table 4, which is not elaborated here.

An embodiment of the present disclosure provides a communication method. Optionally, the method may be performed by a sensing by proxy (SBP) responder and the method may include the following steps:
receiving an SBP request frame, in which the SBP request frame includes first expiry parameter information indicating expiry time of an SBP procedure;
setting, based on the first expiry parameter information, second expiry parameter information indicating expiry time of a sensing measurement procedure, and determining a sensing measurement setup request frame of the sensing measurement procedure; in which the sensing measurement setup request frame includes the second expiry parameter information; and sending the sensing measurement setup request frame.

The SBP request frame includes an SBP parameter information element.

The first expiry parameter information is carried in an SBP parameter control field of the SBP parameter information element. The second expiry parameter information includes measurement setup expiry exponent information.

The SBP request frame and/or the sensing measurement setup request frame includes a sensing measurement parameter information element.

The second expiry parameter information is carried in a sensing measurement parameter field of the sensing measurement parameter information element.

In a case that an SBP initiator identification bit of the SBP parameter information element identifies that an SBP initiator (serving as a sensing responder) participates in a sensing measurement, for example, the sensing responder bit of the SBP parameter information element is set to 1, a transmitter identification bit of the sensing measurement parameter information element indicates that the SBP responder is a transmitter (for example, a sensing transmitter bit of the sensing measurement parameter information element is set to 1), and/or a receiver identification bit of the sensing measurement parameter information element indicates that the SBP responder is a receiver (for example, a sensing receiver bit of the sensing measurement parameter information element is set to 1).

An embodiment of the present disclosure provides a communication method. Optionally, the method may be performed by a sensing by proxy (SBP) responder and the method may include the following steps:
receiving an SBP request frame, in which the SBP request frame includes first expiry parameter information indicating expiry time of an SBP procedure;
setting, based on the first expiry parameter information, second expiry parameter information indicating expiry time of a sensing measurement procedure, and determining a sensing measurement setup request frame of the sensing measurement procedure; in which the sensing measurement setup request frame includes the second expiry parameter information; and
sending the sensing measurement setup request frame.

The SBP request frame includes an SBP parameter information element.

The first expiry parameter information is carried in an SBP parameter control field of the SBP parameter information element. The second expiry parameter information includes measurement setup expiry exponent information.

The SBP request frame and/or the sensing measurement setup request frame includes a sensing measurement parameter information element.

The second expiry parameter information is carried in a sensing measurement parameter field of the sensing measurement parameter information element.

An SBP initiator identification bit of the SBP parameter information element identifies that an SBP initiator participates in a sensing measurement, then the sensing measurement parameter information element includes a triggered based sounding (TB) sensing specific subelement, identifying that the SBP initiator serves as a sensing responder to participate in a TB sensing measurement. As an example, the format of the TB sensing specific subelement is as shown in Table 5 below.

TABLE 5

| | subelement | | AID/ | poll | | | availability |
|---|---|---|---|---|---|---|---|
| content | ID | length | USID | assigned | SR2SR | reserved | window |
| bits | 1 | 4 | 1 | 4 | 1 | 1 | |
| bits order | B0 | B1-B4 | B5 | B6-B9 | B10 | B11 | |

An embodiment of the present disclosure provides a communication method. Optionally, the method may be performed by a sensing by proxy (SBP) responder and the method may include the following steps:
receiving an SBP request frame, in which the SBP request frame includes first expiry parameter information indicating expiry time of an SBP procedure;
setting, based on the first expiry parameter information, second expiry parameter information indicating expiry time of a sensing measurement procedure, and determining a sensing measurement setup request frame of the sensing measurement procedure; in which the sensing measurement setup request frame includes the second expiry parameter information; and
sending the sensing measurement setup request frame.

Optionally, the expiry time of the SBP procedure is later than the expiry time of the sensing measurement procedure.

Optionally, the first expiry parameter information includes SBP procedure expiry exponent information.

Optionally, the SBP request frame includes an SBP parameter information element.

The first expiry parameter information is carried in an SBP parameter control field of the SBP parameter information element.

Optionally, the second expiry parameter information includes measurement setup expiry exponent information.

Optionally, the SBP request frame and/or the sensing measurement setup request frame includes a sensing measurement parameter information element.

The second expiry parameter information is carried in a sensing measurement parameter field of the sensing measurement parameter information element.

Optionally, an SBP initiator identification bit of the SBP parameter information element identifies that an SBP initiator participates in a sensing measurement; a transmitter identification bit of the sensing measurement parameter information element indicates that the SBP responder is a transmitter, and/or a receiver identification bit of the sensing measurement parameter information element indicates that the SBP responder is a receiver.

Optionally, an SBP initiator identification bit of the SBP parameter information element identifies that an SBP initiator participates in a sensing measurement; the sensing measurement parameter information element includes a triggered based sounding (TB) sensing specific subelement.

In the embodiments of the present disclosure, the SBP responder receives an SBP request frame, and obtains first expiry parameter information from the SBP request frame; sets, based on the first expiry parameter information, second expiry parameter information indicating expiry time of a sensing measurement procedure, and determines a sensing measurement setup request frame of the sensing measurement procedure; and sends the sensing measurement setup request frame, in which the sensing measurement setup request frame carries the second expiry parameter information. The embodiments of the present disclosure provide a method for terminating the SBP to further improve the SBP mechanism.

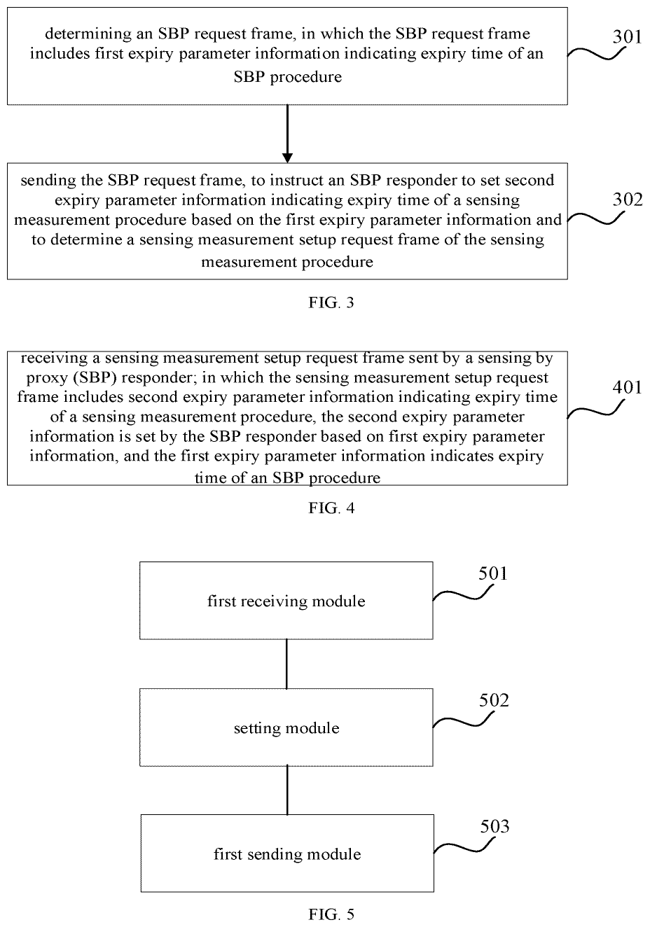

Refer to FIG. 3, an embodiment of the present disclosure provides a communication method. Optionally, the method may be performed by a sensing by proxy (SBP) initiator and the method may include the following steps.

Step 301, an SBP request frame is determined, in which the SBP request frame includes first expiry parameter information indicating expiry time of an SBP procedure.

In a case that the SBP initiator initiates the SBP procedure, the SBP initiator sends the SBP request frame to an SBP responder to request setup of the SBP procedure. The SBP initiator carries the first expiry parameter information in the SBP request frame, and the first expiry parameter information indicates the expiry time of the SBP procedure.

Optionally, the first expiry parameter information may be such as an SBP procedure expiry exponent. The value of the SBP procedure expiry exponent includes an unsigned integer, with the unit being millisecond (ms). For example, in a case that the value of the SBP procedure expiry exponent is zero and there is no frame exchange sequence, then the SBP procedure terminates.

Step 302, the SBP request frame is sent, to instruct an SBP responder to set second expiry parameter information indicating expiry time of a sensing measurement procedure based on the first expiry parameter information and to determine a sensing measurement setup request frame of the sensing measurement procedure; in which the sensing measurement setup request frame includes the second expiry parameter information.

The SBP initiator sends the SBP request frame. After the SBP responder receives the SBP request frame, based on the first expiry parameter information in the SBP request frame, the SBP responder determines and sets the second expiry parameter information in the sensing measurement procedure.

Specifically, after the SBP responder receives the SBP request frame, the SBP responder initiates the sensing measurement procedure (a triggered based sounding (TB) sensing measurement) based on the SBP request frame, and establishes the sensing measurement procedure by sending the sensing measurement setup request frame to an STA. The second expiry parameter information for indicating the expiry time of the sensing measurement procedure is carried in the sensing measurement setup request frame, and the second expiry parameter information is used to terminate the sensing measurement procedure.

Furthermore, the sensing measurement procedure initiated by the SBP responder terminates before termination of the SBP procedure.

An embodiment of the present disclosure provides a communication method. Optionally, the method may be performed by a sensing by proxy (SBP) initiator and the method may include the following steps:
determining an SBP request frame, in which the SBP request frame includes first expiry parameter information indicating expiry time of an SBP procedure; and
sending the SBP request frame, to instruct an SBP responder to set second expiry parameter information indicating expiry time of a sensing measurement procedure based on the first expiry parameter information and to determine a sensing measurement setup request frame of the sensing measurement procedure; in which the sensing measurement setup request frame includes the second expiry parameter information.

The expiry time of the SBP procedure is later than the expiry time of the sensing measurement procedure to ensure that the sensing measurement procedure initiated by the SBP responder terminates before termination of the SBP procedure, thereby standardizing the SBP procedure.

An embodiment of the present disclosure provides a communication method. Optionally, the method may be performed by a sensing by proxy (SBP) initiator and the method may include the following steps:
determining an SBP request frame, in which the SBP request frame includes first expiry parameter information indicating expiry time of an SBP procedure; and
sending the SBP request frame, to instruct an SBP responder to set second expiry parameter information indicating expiry time of a sensing measurement procedure based on the first expiry parameter information and to determine a sensing measurement setup request frame of the sensing measurement procedure; in which the sensing measurement setup request frame includes the second expiry parameter information.

The first expiry parameter information includes an SBP procedure expiry exponent. The value of the SBP procedure expiry exponent includes an unsigned integer, with the unit being millisecond (ms). For example, in a case that the value of the SBP procedure expiry exponent is zero and there is no frame exchange sequence, then the SBP procedure terminates.

An embodiment of the present disclosure provides a communication method. Optionally, the method may be performed by a sensing by proxy (SBP) initiator and the method may include the following steps:
determining an SBP request frame, in which the SBP request frame includes first expiry parameter information indicating expiry time of an SBP procedure; and
sending the SBP request frame, to instruct an SBP responder to set second expiry parameter information indicating expiry time of a sensing measurement procedure based on the first expiry parameter information and to determine a sensing measurement setup request frame of the sensing measurement procedure; in which the sensing measurement setup request frame includes the second expiry parameter information.

The SBP request frame includes an SBP parameter information element. As an example, the format of the SBP parameter information element is as shown in the aforementioned Table 1.

The first expiry parameter information may be such as an SBP procedure expiry exponent. The first expiry parameter information is carried in the SBP parameter control field of the SBP parameter information element. Furthermore, the format of the SBP parameter control field is as shown in the aforementioned Table 2.

An embodiment of the present disclosure provides a communication method. Optionally, the method may be performed by a sensing by proxy (SBP) initiator and the method may include the following steps:
determining an SBP request frame, in which the SBP request frame includes first expiry parameter information indicating expiry time of an SBP procedure; and
sending the SBP request frame, to instruct an SBP responder to set second expiry parameter information indicating expiry time of a sensing measurement procedure based on the first expiry parameter information and to determine a sensing measurement setup request frame of the sensing measurement procedure; in which the sensing measurement setup request frame includes the second expiry parameter information.

The SBP request frame includes an SBP parameter information element.

The first expiry parameter information is carried in an SBP parameter control field of the SBP parameter information element. The second expiry parameter information includes measurement setup expiry exponent information. The value of the measurement setup expiry exponent information includes an unsigned integer, with the unit being millisecond (ms). For example, in a case that the value of the measurement setup expiry exponent information is zero and there is no frame exchange sequence, then the TB sensing measurement procedure terminates.

An embodiment of the present disclosure provides a communication method. Optionally, the method may be performed by a sensing by proxy (SBP) initiator and the method may include the following steps:
determining an SBP request frame, in which the SBP request frame includes first expiry parameter information indicating expiry time of an SBP procedure; and
sending the SBP request frame, to instruct an SBP responder to set second expiry parameter information indicating expiry time of a sensing measurement procedure based on the first expiry parameter information and to determine a sensing measurement setup request frame of the sensing measurement procedure; in which the sensing measurement setup request frame includes the second expiry parameter information.

The SBP request frame includes an SBP parameter information element.

The first expiry parameter information is carried in an SBP parameter control field of the SBP parameter information element. The second expiry parameter information includes measurement setup expiry exponent information.

The SBP request frame and/or the sensing measurement setup request frame includes a sensing measurement parameter information element. The sensing measurement parameter information element identifies parameter information necessary for the SBP initiator to initiate an SBP measurement procedure, such as bandwidth (BW), number of space-time streams (NST), and max long training field (LTF) etc. As an example, the format of the sensing measurement parameter information element is as shown in the aforementioned Table 3.

The second expiry parameter information is carried in a sensing measurement parameter field of the sensing measurement parameter information element. The second expiry parameter information (the measurement setup expiry exponent) is carried in the sensing measurement parameter field of the sensing measurement parameter information element. The format of the sensing measurement parameter field is as shown in the aforementioned Table 4.

An embodiment of the present disclosure provides a communication method. Optionally, the method may be performed by a sensing by proxy (SBP) initiator and the method may include the following steps:
determining an SBP request frame, in which the SBP request frame includes first expiry parameter information indicating expiry time of an SBP procedure; and
sending the SBP request frame, to instruct an SBP responder to set second expiry parameter information indicating expiry time of a sensing measurement procedure based on the first expiry parameter information and to determine a sensing measurement setup request frame of the sensing measurement procedure; in which the sensing measurement setup request frame includes the second expiry parameter information.

The SBP request frame includes an SBP parameter information element.

The first expiry parameter information is carried in an SBP parameter control field of the SBP parameter information element.

The second expiry parameter information includes measurement setup expiry exponent information.

The SBP request frame and/or the sensing measurement setup request frame includes a sensing measurement parameter information element.

The second expiry parameter information is carried in a sensing measurement parameter field of the sensing measurement parameter information element.

In a case that an SBP initiator identification bit of the SBP parameter information element identifies that an SBP initiator (serving as a sensing responder) participates in a sensing measurement, for example, the sensing responder bit of the SBP parameter information element is set to 1, a transmitter identification bit of the sensing measurement parameter information element indicates that the SBP responder is a transmitter (for example, a sensing transmitter bit of the sensing measurement parameter information element is set to 1), and/or a receiver identification bit of the sensing measurement parameter information element indicates that the SBP responder is a receiver (for example, a sensing receiver bit of the sensing measurement parameter information element is set to 1).

An embodiment of the present disclosure provides a communication method. Optionally, the method may be performed by a sensing by proxy (SBP) initiator and the method may include the following steps:
determining an SBP request frame, in which the SBP request frame includes first expiry parameter information indicating expiry time of an SBP procedure; and
sending the SBP request frame, to instruct an SBP responder to set second expiry parameter information indicating expiry time of a sensing measurement procedure based on the first expiry parameter information and to determine a sensing measurement setup request frame of the sensing measurement procedure; in which the sensing measurement setup request frame includes the second expiry parameter information.

The SBP request frame includes an SBP parameter information element.

The first expiry parameter information is carried in an SBP parameter control field of the SBP parameter information element.

The second expiry parameter information includes measurement setup expiry exponent information.

The SBP request frame and/or the sensing measurement setup request frame includes a sensing measurement parameter information element.

The second expiry parameter information is carried in a sensing measurement parameter field of the sensing measurement parameter information element.

An SBP initiator identification bit of the SBP parameter information element identifies that an SBP initiator participates in a sensing measurement, then the sensing measurement parameter information element includes a triggered based sounding (TB) sensing specific subelement, identifying that the SBP initiator serves as a sensing responder to participate in a TB sensing measurement. As an example, the format of the TB sensing specific subelement is as shown in the aforementioned Table 5.

An embodiment of the present disclosure provides a communication method. Optionally, the method may be performed by a sensing by proxy (SBP) initiator and the method may include the following steps:
determining an SBP request frame, in which the SBP request frame includes first expiry parameter information indicating expiry time of an SBP procedure; and
sending the SBP request frame, to instruct an SBP responder to set second expiry parameter information indicating expiry time of a sensing measurement procedure based on the first expiry parameter information and to determine a sensing measurement setup request frame of the sensing measurement procedure; in which the sensing measurement setup request frame includes the second expiry parameter information.

The SBP request frame includes an SBP parameter information element.

The first expiry parameter information is carried in an SBP parameter control field of the SBP parameter information element.

The second expiry parameter information includes measurement setup expiry exponent information.

The value of the measurement setup expiry exponent information is less than the value of the SBP procedure expiry exponent information. The SBP initiator may set the value of the measurement setup expiry exponent based on the value set for the SBP procedure expiry exponent. The SBP initiator set the value of the measurement setup expiry exponent to be less than the value of the SBP procedure expiry exponent, so that the expiry time of the SBP procedure is later than the expiry time of the sensing measurement procedure, so as to ensure that the sensing measurement procedure initiated by the SBP responder terminates before termination of the SBP procedure, thereby standardizing the SBP procedure.

An embodiment of the present disclosure provides a communication method. Optionally, the method may be performed by a sensing by proxy (SBP) initiator and the method may include the following steps:
determining an SBP request frame, in which the SBP request frame includes first expiry parameter information indicating expiry time of an SBP procedure; and
sending the SBP request frame, to instruct an SBP responder to set second expiry parameter information indicating expiry time of a sensing measurement procedure based on the first expiry parameter information and to determine a sensing measurement setup request frame of the sensing measurement procedure; in which the sensing measurement setup request frame includes the second expiry parameter information.

Optionally, the expiry time of the SBP procedure is later than the expiry time of the sensing measurement procedure.

Optionally, the first expiry parameter information includes SBP procedure expiry exponent information.

Optionally, the SBP request frame includes an SBP parameter information element.

The first expiry parameter information is carried in an SBP parameter control field of the SBP parameter information element.

Optionally, the second expiry parameter information includes measurement setup expiry exponent information.

Optionally, the SBP request frame and/or the sensing measurement setup request frame includes a sensing measurement parameter information element.

The second expiry parameter information is carried in a sensing measurement parameter field of the sensing measurement parameter information element.

Optionally, an SBP initiator identification bit of the SBP parameter information element identifies that an SBP initiator participates in a sensing measurement; a transmitter identification bit of the sensing measurement parameter information element indicates that the SBP responder is a transmitter, and/or a receiver identification bit of the sensing measurement parameter information element indicates that the SBP responder is a receiver.

Optionally, an SBP initiator identification bit of the SBP parameter information element identifies that an SBP initiator participates in a sensing measurement; the sensing measurement parameter information element includes a triggered based sounding (TB) sensing specific subelement.

Optionally, a value of the measurement setup expiry exponent information is smaller than a value of the SBP procedure expiry exponent information.

In the embodiments of the present disclosure, the SBP initiator determines an SBP request frame carrying first expiry parameter information, so that the SBP responder sets, based on the first expiry parameter information, second expiry parameter information indicating expiry time of a sensing measurement procedure, and determines a sensing measurement setup request frame of the sensing measurement procedure; in which the sensing measurement setup request frame carries the second expiry parameter information. The embodiments of the present disclosure provide a method for terminating the SBP to further improve the SBP mechanism.

Refer to FIG. 4, an embodiment of the present disclosure provides a communication method. Optionally, the method may be performed by a station. The station may include the SBP initiator in the aforementioned embodiments.

The method may include the following steps.

Step 401, a sensing measurement setup request frame sent by a sensing by proxy (SBP) responder is received; in which the sensing measurement setup request frame includes second expiry parameter information indicating expiry time of a sensing measurement procedure, the second expiry parameter information is set by the SBP responder based on first expiry parameter information, and the first expiry parameter information indicates expiry time of an SBP procedure.

In a case that an SBP initiator initiates the SBP procedure, the SBP initiator sends an SBP request frame to the SBP responder to request setup of the SBP procedure. The SBP initiator carries the first expiry parameter information in the SBP request frame, and the first expiry parameter information indicates the expiry time of the SBP procedure.

Optionally, the first expiry parameter information may be such as an SBP procedure expiry exponent. The value of the SBP procedure expiry exponent includes an unsigned integer, with the unit being millisecond (ms). For example, in a case that the value of the SBP procedure expiry exponent is zero and there is no frame exchange sequence, then the SBP procedure terminates.

After the SBP responder receives the SBP request frame, the SBP responder initiates the sensing measurement procedure (a triggered based sounding (TB) sensing measurement) based on the SBP request frame, and establishes the sensing measurement procedure by sending the sensing measurement setup request frame to an STA. The second expiry parameter information for indicating the expiry time of the sensing measurement procedure is carried in the sensing measurement setup request frame, and the second expiry parameter information is used to terminate the sensing measurement procedure. Furthermore, the sensing measurement procedure initiated by the SBP responder terminates before termination of the SBP procedure.

In the embodiments of the present disclosure, the station also performs the other steps carried out by the station in the aforementioned embodiments, which will not be elaborated here.

Refer to FIG. 5, based on the same principle as the method provided by the embodiments of the present disclosure, an embodiment of the present disclosure also provides an electronic device. The electronic device is a sensing by proxy (SBP) responder and includes a first receiving module 501, a setting module 502, and a first sending module 503.

The first receiving module 501 is configured to receive an SBP request frame, in which the SBP request frame includes first expiry parameter information indicating expiry time of an SBP procedure.

The setting module 502 is configured to set, based on the first expiry parameter information, second expiry parameter information indicating expiry time of a sensing measurement procedure, and determine a sensing measurement setup request frame of the sensing measurement procedure; in which the sensing measurement setup request frame includes the second expiry parameter information.

The first sending module 503 is configured to send the sensing measurement setup request frame.

Optionally, the expiry time of the SBP procedure is later than the expiry time of the sensing measurement procedure.

Optionally, the first expiry parameter information includes SBP procedure expiry exponent information.

Optionally, the SBP request frame includes an SBP parameter information element.

The first expiry parameter information is carried in an SBP parameter control field of the SBP parameter information element.

Optionally, the second expiry parameter information includes measurement setup expiry exponent information.

Optionally, the SBP request frame and/or the sensing measurement setup request frame includes a sensing measurement parameter information element.

The second expiry parameter information is carried in a sensing measurement parameter field of the sensing measurement parameter information element.

Optionally, an SBP initiator identification bit of the SBP parameter information element identifies that an SBP initiator participates in a sensing measurement; a transmitter identification bit of the sensing measurement parameter information element indicates that the SBP responder is a transmitter, and/or a receiver identification bit of the sensing measurement parameter information element indicates that the SBP responder is a receiver.

Optionally, an SBP initiator identification bit of the SBP parameter information element identifies that an SBP initiator participates in a sensing measurement; the sensing measurement parameter information element includes a triggered based sounding (TB) sensing specific subelement.

The embodiments of the present disclosure provide a communication apparatus, applied to a sensing by proxy (SBP) responder. The apparatus includes a first request receiving module, a parameter setting module, and a first request sending module.

The first request receiving module is configured to receive an SBP request frame, in which the SBP request frame includes first expiry parameter information indicating expiry time of an SBP procedure.

The parameter setting module is configured to set, based on the first expiry parameter information, second expiry parameter information indicating expiry time of a sensing measurement procedure, and determine a sensing measurement setup request frame of the sensing measurement procedure; in which the sensing measurement setup request frame includes the second expiry parameter information.

The first request sending module is configured to send the sensing measurement setup request frame.

The apparatus also includes other modules of the electronic device as mentioned in the aforementioned embodiments, which will not be elaborated here.

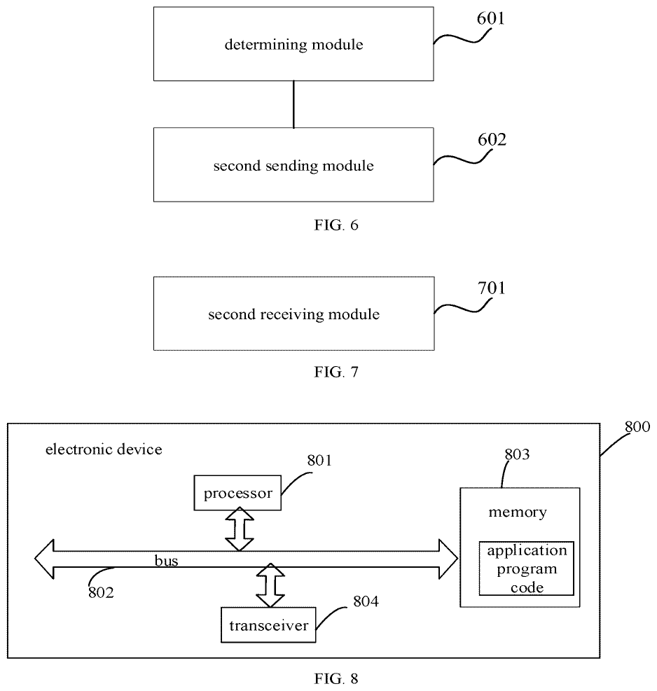

Refer to FIG. 6, based on the same principle as the method provided by the embodiments of the present disclosure, an embodiment of the present disclosure also provides an electronic device. The electronic device is a sensing by proxy (SBP) initiator and includes a determining module 601, and a second sending module 602.

The determining module 601 is configured to determine an SBP request frame, in which the SBP request frame includes first expiry parameter information indicating expiry time of an SBP procedure.

The second sending module 602 is configured to send the SBP request frame, to instruct an SBP responder to set second expiry parameter information indicating expiry time of a sensing measurement procedure based on the first expiry parameter information and to determine a sensing measurement setup request frame of the sensing measurement procedure; in which the sensing measurement setup request frame includes the second expiry parameter information.

Optionally, the expiry time of the SBP procedure is later than the expiry time of the sensing measurement procedure.

Optionally, the first expiry parameter information includes SBP procedure expiry exponent information.

Optionally, the SBP request frame includes an SBP parameter information element.

The first expiry parameter information is carried in an SBP parameter control field of the SBP parameter information element.

Optionally, the second expiry parameter information includes measurement setup expiry exponent information.

Optionally, the SBP request frame and/or the sensing measurement setup request frame includes a sensing measurement parameter information element.

The second expiry parameter information is carried in a sensing measurement parameter field of the sensing measurement parameter information element.

Optionally, an SBP initiator identification bit of the SBP parameter information element identifies that an SBP initiator participates in a sensing measurement; a transmitter identification bit of the sensing measurement parameter information element indicates that the SBP responder is a transmitter, and/or a receiver identification bit of the sensing measurement parameter information element indicates that the SBP responder is a receiver.

Optionally, an SBP initiator identification bit of the SBP parameter information element identifies that an SBP initiator participates in a sensing measurement; the sensing measurement parameter information element includes a triggered based sounding (TB) sensing specific subelement.

Optionally, a value in the measurement setup expiry exponent information is smaller than a value in the SBP procedure expiry exponent information.

The embodiments of the present disclosure provide a communication apparatus, applied to a sensing by proxy (SBP) initiator. The apparatus includes a request determining module, and a second request sending module.

The request determining module is configured to determine an SBP request frame, in which the SBP request frame includes first expiry parameter information indicating expiry time of an SBP procedure;

The second request sending module is configured to send the SBP request frame, to instruct an SBP responder to set second expiry parameter information indicating expiry time of a sensing measurement procedure based on the first expiry parameter information and to determine a sensing measurement setup request frame of the sensing measurement procedure; in which the sensing measurement setup request frame includes the second expiry parameter information.

The apparatus also includes other modules of the electronic device as mentioned in the aforementioned embodiments, which will not be elaborated here.

Refer to FIG. 7, based on the same principle as the method provided by the embodiments of the present disclosure, an embodiment of the present disclosure also provides an electronic device. The electronic device is a station and includes a second receiving module 701.

The second receiving module 701 is configured to receive a sensing measurement setup request frame sent by a sensing by proxy (SBP) responder; in which the sensing measurement setup request frame comprises second expiry parameter information indicating expiry time of a sensing measurement procedure, the second expiry parameter information is set by the SBP responder based on first expiry parameter information, and the first expiry parameter information indicates expiry time of an SBP procedure.

The embodiments of the present disclosure provide a communication apparatus, applied to a station. The apparatus includes a second request receiving module.

The second request receiving module is configured to receive a sensing measurement setup request frame sent by a sensing by proxy (SBP) responder; in which the sensing measurement setup request frame comprises second expiry parameter information indicating expiry time of a sensing measurement procedure, the second expiry parameter information is set by the SBP responder based on first expiry parameter information, and the first expiry parameter information indicates expiry time of an SBP procedure.

The apparatus also includes other modules of the electronic device as mentioned in the aforementioned embodiments, which will not be elaborated here.

In an optional embodiment, the present disclosure also provides an electronic device. As shown in FIG. 8, the electronic device 800 shown in FIG. 8 may be a server and includes: a processor 801 and a memory 803. The processor 801 and the memory 803 are connected, such as through a bus 802. Optionally, the electronic device 800 may also include a transceiver 804. It should be noted that in actual applications, the number of transceivers 804 is not limited to one, and the structure of the electronic device 800 does not constitute a limitation to the present disclosure.

The processor 801 may be a central processing unit (CPU), a general-purpose processor, a digital signal processor (DSP), an application specific integrated circuit (ASIC), a field programmable gate array (FPGA), or other programmable logic devices, transistor logic devices, hardware components, or any combination thereof. The processor 801 may be used for implementing or executing various logic blocks, modules, and circuits described in conjunction with the present disclosure. The processor 801 may also be a combination that implements computing functions, such as a combination of one or more microprocessors, a combination of a DSP and a microprocessor, etc.

The bus 802 may include a path for transmitting information among the aforementioned components. The bus 802 may be a peripheral component interconnect (PCI) bus or an extended industry standard architecture (EISA) bus, etc. The bus 802 may be classified into an address bus, a data bus, a control bus, etc. For ease of representation, only a thick line is used in FIG. 8 to represent the bus, but it does not imply that there is only one bus or only one type of buses.

The memory 803 may be a read only memory (ROM) or other types of static storage devices that may store static information and instructions, a random access memory (RAM) or other types of dynamic storage devices that may store information and instructions, an electrically erasable programmable read only memory (EEPROM), a compact disc read only memory (CD-ROM), or other optical disk storage media or optical disc storage media (including a compressed optical disk, a laser disk, an optical disk, a digital versatile disk, a Blu-ray disk, etc.), a magnetic disk storage medium or other magnetic storage devices, or any other medium that may be used to carry or store program codes in the form of instructions or data structures and may be accessed by a computer, but is not limited to this.

The memory 803 is used to store the application program code for implementing the technical solution of the present disclosure, and is controlled to execute by the processor 801. The processor 801 is used to execute the application program code stored in memory 803 to achieve the content as described in the aforementioned method embodiments.

The electronic device includes but is not limited to: a mobile terminal such as a mobile phone, a laptop, a digital radio receiver, a personal digital assistant (PDA), a tablet computer (PAD), a portable multimedia player (PMP), or a mobile terminal (such as an in-vehicle navigation terminal), etc., as well as a fixed terminal such as a digital TV, or a desktop computer, etc. The electronic device shown in FIG. 8 is merely an example and should not impose any limitations on the functions and usage scope of the present disclosure.

The server provided by the present disclosure may be an independent physical server, a server cluster composed of a plurality of physical servers, or a distributed system. It may also be a cloud server that provides basic cloud computing services such as a cloud service, a cloud database, cloud computing, a cloud function, cloud storage, a network service, cloud communication, a middleware service, a domain name service, a security service, CDN, and big data and an artificial intelligence platform. The terminal may be a smart phone, a tablet computer, a laptop computer, a desktop computer, a smart speaker, a smart watch, etc., but is not limited to these. The terminal and the server may be directly or indirectly connected through wired or wireless communication, which is not limited in the present disclosure.

The embodiments of the present disclosure provide a computer-readable storage medium, on which a computer program is stored. When the computer program is run on a computer, the computer is caused to execute the corresponding contents of the aforementioned method embodiments.

It should be understood that although the steps in the flowchart of the attached figures are displayed sequentially according to the arrows, these steps are not necessarily executed in the order indicated by the arrows. Unless explicitly stated in the disclosure, there is no strict sequence restriction on the execution of these steps, and they may be executed in other orders. Moreover, at least some of the steps in the flowchart of the attached figure may include multiple sub-steps or multiple stages. These sub-steps or stages do not necessarily need to be completed at the same time, but may be executed at different times, and their execution order does not necessarily proceed sequentially, but may be executed alternately or in rotation with at least some other steps or sub-steps or stages of other steps.

It should be noted that the computer-readable medium mentioned above in the disclosure may be a computer-readable signal medium, or a computer-readable storage medium, or any combination of the two. The machine-readable media may be such as, but are not limited to, electronic, magnetic, optical, electromagnetic, infrared, or semiconductor systems, apparatuses or devices, or any suitable combination thereof. More specific examples of machine-readable storage media may include electrical connections based on one or more wires, a portable computer disk, a hard disk, a random access memory (RAM), a read-only memory (ROM), an erasable programmable read only memory (EPROM or flash memory), an optical fiber, a compact disk read only memory (CD-ROM), an optical storage device, a magnetic storage device, or any suitable combination thereof. In the disclosure, the computer-readable storage medium may be any tangible medium that contains or stores a program, which may be executed by an instruction-executing system, device or component, or used in combination with it. In the disclosure, the computer-readable signal medium may include data signals carried in a baseband or as part of a carrier, where the data signals carry computer-readable program code. Such propagated data signals may take various forms, including but not limited to electromagnetic signals, optical signals, or any suitable combination of the above. The computer-readable signal medium may also be any computer-readable medium other than a computer-readable storage medium, and the computer-readable signal medium may send, propagate or transmit a program for use by an instruction-executing system, device or component or in combination with it. The program code contained in the computer-readable medium may be transmitted using any appropriate medium, including but not limited to: wires, optical cables, RF (radio frequency), etc., or any suitable combination of the above.

The above computer-readable medium may be contained within the above electronic device, or may exist independently and not be assembled into the electronic device.

The above computer-readable medium carries one or more programs. When these one or more programs are executed by the electronic device, the electronic device performs the method as described in the above embodiment.

According to one aspect of the present disclosure, a computer program product or a computer program is provided. The computer program product or the computer program includes a computer instruction, which is stored in the computer-readable storage medium. A processor of a computer device reads the computer instruction from the computer-readable storage medium, and the processor executes the computer instruction, thereby enabling the computer device to perform the methods provided in the various optional embodiments mentioned above.

Program codes configured to implement the methods in the present disclosure may be written in one or multiple programming languages, or any combination thereof. The programming languages include object-oriented programming languages such as Java, Smalltalk, C++, as well as conventional procedural programming languages such as “C” language or similar programming languages. The program codes may be executed entirely on a user computer, partially on a user computer, partially on a user computer and partially on a remote computer as a stand-alone software package, or entirely on a remote computer or a server. In a case that involving remote computers, the remote computer may be connected to the user computer through any type of networks, including local area networks (LANs) or wide area networks (WANs); or the remote computer may be connected to an external computer (for example, via the Internet by using an Internet service provider).

The flowcharts and block diagrams in the attached figures illustrate the possible architectures, functions and operations of the systems, methods and computer program products according to various embodiments of the present disclosure. In this regard, each box in the flowchart or block diagram may represent a module, a program segment, or a part of the code, which contains one or more executable instructions for implementing the specified logical functions. It should also be noted that in some alternative implementations, the functions indicated in the boxes may occur in a different order than that indicated in the figures. For example, two consecutive boxes may actually be executed in a basically parallel manner, and they may sometimes be executed in the opposite order, depending on the functions involved. It should also be noted that each box in the block diagram and/or flowchart, as well as the combinations of boxes in the block diagram and/or flowchart, may be implemented using a dedicated hardware-based system that performs the specified functions or operations, or using a combination of dedicated hardware and computer instructions.

The modules described in the present disclosure may be realized in a software manner or in a hardware manner. In some cases, the name of a module does not limit the module itself. For example, module A may also be described as “module A for performing operation B”.

The above description merely shows some embodiments of the present disclosure and an explanation of the technical principles. Those skilled in the art should understand that the scope of the disclosure herein is not limited to the technical solution formed by a specific combination of the aforementioned technical features, but also encompasses other technical solutions formed by any combination of the aforementioned technical features or their equivalents, without departing from the aforementioned disclosure concept. For example, such technical solutions may be formed by replacing the aforementioned features with the (but not limited to) technical features having similar functions disclosed in the present disclosure.

1. A communication method, performed by a sensing by proxy (SBP) responder, comprising:
receiving an SBP request frame, wherein the SBP request frame comprises first expiry parameter information indicating expiry time of an SBP procedure;
setting, based on the first expiry parameter information, second expiry parameter information indicating expiry time of a sensing measurement procedure, and determining a sensing measurement setup request frame of the sensing measurement procedure; wherein the sensing measurement setup request frame comprises the second expiry parameter information; and
sending the sensing measurement setup request frame.

2. The communication method according to claim 1, wherein the expiry time of the SBP procedure is later than the expiry time of the sensing measurement procedure.

3. The communication method according to claim 1, wherein the first expiry parameter information comprises SBP procedure expiry exponent information.

4. The communication method according to claim 1, wherein the SBP request frame comprises an SBP parameter information element; and
the first expiry parameter information is carried in an SBP parameter control field of the SBP parameter information element.

5. The communication method according to claim 4, wherein the second expiry parameter information comprises measurement setup expiry exponent information.

6. The communication method according to claim 5, wherein at least one of the SBP request frame or the sensing measurement setup request frame comprises a sensing measurement parameter information element; and
the second expiry parameter information is carried in a sensing measurement parameter field of the sensing measurement parameter information element.

7. The communication method according to claim 6, wherein an SBP initiator identification bit of the SBP parameter information element identifies that an SBP initiator participates in a sensing measurement; a transmitter identification bit of the sensing measurement parameter information element indicates that the SBP responder is a transmitter, or a receiver identification bit of the sensing measurement parameter information element indicates that the SBP responder is a receiver, or a transmitter identification bit of the sensing measurement parameter information element indicates that the SBP responder is a transmitter and a receiver identification bit of the sensing measurement parameter information element indicates that the SBP responder is a receiver;
or
wherein an SBP initiator identification bit of the SBP parameter information element identifies that an SBP initiator participates in a sensing measurement; the sensing measurement parameter information element comprises a triggered based sounding (TB) sensing specific sub-element.

8. (canceled)

9. The communication method according to claim 5, wherein a value in the measurement setup expiry exponent information is smaller than a value in the SBP procedure expiry exponent information.

10. A communication method, performed by a sensing by proxy (SBP) initiator, comprising:
determining an SBP request frame, wherein the SBP request frame comprises first expiry parameter information indicating expiry time of an SBP procedure;
sending the SBP request frame, to instruct an SBP responder to set second expiry parameter information indicating expiry time of a sensing measurement procedure based on the first expiry parameter information and to determine a sensing measurement setup request frame of the sensing measurement procedure; wherein the sensing measurement setup request frame comprises the second expiry parameter information.

11. The communication method according to claim 10, wherein the expiry time of the SBP procedure is later than the expiry time of the sensing measurement procedure.

12. The communication method according to claim 10, wherein the first expiry parameter information comprises SBP procedure expiry exponent information.

13. The communication method according to claim 10, wherein the SBP request frame comprises an SBP parameter information element; and
the first expiry parameter information is carried in an SBP parameter control field of the SBP parameter information element.

14. The communication method according to claim 13, wherein the second expiry parameter information comprises measurement setup expiry exponent information.

15. The communication method according to claim 14, wherein at least one of the SBP request frame or the sensing measurement setup request frame comprises a sensing measurement parameter information element; and
the second expiry parameter information is carried in a sensing measurement parameter field of the sensing measurement parameter information element.

16. The communication method according to claim 15, wherein an SBP initiator identification bit of the SBP parameter information element identifies that an SBP initiator participates in a sensing measurement; a transmitter identification bit of the sensing measurement parameter information element indicates that the SBP responder is a transmitter, or a receiver identification bit of the sensing measurement parameter information element indicates that the SBP responder is a receiver, or a transmitter identification bit of the sensing measurement parameter information element indicates that the SBP responder is a transmitter and a receiver identification bit of the sensing measurement parameter information element indicates that the SBP responder is a receiver;
or
wherein an SBP initiator identification bit of the SBP parameter information element identifies that an SBP initiator participates in a sensing measurement; the sensing measurement parameter information element comprises a triggered based sounding (TB) sensing specific sub-element.

17. (canceled)

18. The communication method according to claim 14, wherein a value in the measurement setup expiry exponent information is smaller than a value in the SBP procedure expiry exponent information.

19. A communication method, performed by a station, comprising:
receiving a sensing measurement setup request frame sent by a sensing by proxy (SBP) responder; wherein the sensing measurement setup request frame comprises second expiry parameter information indicating expiry time of a sensing measurement procedure, the second expiry parameter information is set by the SBP responder based on first expiry parameter information, and the first expiry parameter information indicates expiry time of an SBP procedure.

20-22. (canceled)

23. An electronic device, comprising a memory, a processor, and a computer program stored in the memory and executable on the processor, wherein when the processor executes the computer program, a method according to claim 1 is implemented.

24. (canceled)

25. An electronic device, comprising a memory, a processor, and a computer program stored in the memory and executable on the processor, wherein when the processor executes the computer program, the communication method according to claim 10 is implemented.

26. An electronic device, comprising a memory, a processor, and a computer program stored in the memory and executable on the processor, wherein when the processor executes the computer program, the communication method according to claim 19 is implemented.
